(19) United States
(12) Patent Application Publication
(10) Pub. No.: US 2011/0297292 A1
(43) Pub. Date: Dec. 8, 2011

(54) METHOD FOR PRODUCING AN IMPROVED ELECTRICAL STEEL STRIP

(75) Inventors: Jochen Bogner, Leonding (AT); Franz Citroni, Linz (AT); Gerald Kasberger, Kollerschlag (AT)

(73) Assignee: VOESTALPINE STAHL GMBH, Linz (AT)

(21) Appl. No.: 13/139,282

(22) PCT Filed: Oct. 23, 2009
(86) PCT No.: PCT/EP2009/063964

§ 371 Date: Aug. 25, 2011

(30) Foreign Application Priority Data
Dec. 12, 2008 (DE) 102008061983.3-24

(51) Int. Cl. C23C 8/14; B32B 37/14; C22C 38/00

(52) U.S. Cl. 156/60; 148/284; 148/320

(57) ABSTRACT

The invention relates to a method for producing an electric steel strip, in particular an iron oxide-coated steel strip for use as electric sheet steel for the electrical industry; the steel strip is fed in a continuous process to a closed treatment chamber; the electric steel is conveyed into the treatment chamber at a temperature between 450° C. and 550° C. and is acted on there with compressed air and an oxygen concentration of between 0.05% and 0.2% oxygen, measured in the entire furnace chamber atmosphere; and the dew point of water is set to below −10° C. and the furnace chamber atmosphere is a reducing atmosphere; the invention also relates to the electric sheet steel and its use.

### FIELD OF THE INVENTION

The invention relates to a method for producing an improved electric steel strip, the electric steel strip produced with the method, and its use.

### BACKGROUND OF THE INVENTION

The stators of electric motors are made of so-called electric steel. Electric steel is a band steel sheet with thicknesses of between 0.3 mm and 1.2 mm, for example.

This band steel sheet is stamped into the required shapes and the individually stamped components are assembled to form corresponding stator lamination cores, which are then wound with the corresponding coils. If such an iron core is used in a coil, then its ferromagnetic properties—which are preset by the steel manufacturer or at least are prepared so that the user sets these properties by means of a final annealing—increase the permeability and thus also the magnetic flux density in the coil. This makes it possible to reduce the number of windings needed to achieve a required inductance.

Because the iron of the core is an electrical conductor, in a coil with an iron core through which alternating current is flowing, a current that is referred to as eddy current flows in a quasi-short circuited winding in this coil. This eddy current is less powerful if the core is not made from one piece of iron, but from a stack of the above-described steel sheets. To really reduce this eddy current, however, the steel sheets or steel plates must be insulated from one another.

There are three common ways to insulate these plates of electric steel from one another, namely coating the steel surface with an organic varnish, coating the steel surface with an inorganic varnish, or oxidizing the steel surface. Oxidation of the steel surface is carried out particularly in electric steel used for stators of small motors, i.e. motors used in the household appliance industry, for example.

Such layers, which are obtained by bluing, are mixed layers composed of approximately equal parts of Fe₂O₃ and Fe₃O₄. These bluing treatments are performed by the user in electric steel furnaces by increasing the dew point or in bluing furnaces especially designed for this purpose, likewise by increasing the dew point. FIG. 2 shows one such bluing device according to the prior art, of a type employed by many users of electric sheet steel.

In this system 101, the strip 103 is unwound from a coil 102 of wound steel strip 103 at an uncoiling station 104. The steel strip 103 travels into a stamping press 105; in the stamping press, the sheets, e.g. for a coil core, are stamped out from the steel strip 103. The stamped sheets are stacked to form stamped part stacks 106; the stacks then travel into an annealing furnace 107. After a definite processing time at 650° C. to 750° C., the stamped part stacks 106 travel into a bluing furnace 108. In the inner chamber 109 of the bluing furnace 108, an atmosphere is adjusted in which the dew point is >10° C. and in particular, is >20° C.; the atmosphere is oxidizing at a temperature of approx. 500° C. After the predetermined sufficient processing time, the stamped part stacks, as a finished product stacks 110, exit the bluing furnace; the finished products have a mixed layer coating composed of approximately half Fe₂O₃ and half Fe₃O₄, usually with a layer coating thickness of 200 nm.

The previous methods have the disadvantage that insulating with varnishes is relatively expensive and varnishes involve fundamental problems with respect to the environment, particularly as regards subsequent waste management.

A disadvantage of bluing is that it also entails an additional work step; furthermore, bluing does not achieve the same insulating power as varnishing and also, processes of this kind are often carried out by the user, without really achieving reliably uniform properties.

The object of the invention is to create a method for producing an electric steel strip, which can be simply and inexpensively carried out, ensures an insulation layer with a reliable insulation and favorably controllable uniform properties, and is also inexpensive.

Another object of the invention is to create an electric steel strip, which is embodied with a good insulation and can be used without further remachining for the production of laminated cores.

### SUMMARY OF THE INVENTION

According to the invention, the electric steel strip is already provided with an insulating layer at the steel manufacturer in a continuous process and in particular, during recrystallization annealing in a continuous annealing line. This does in fact cause the electric steel strip to take on a blue color, but the insulating layer provides a significantly better insulation as compared to a conventionally blued layer. The manufactured electric steel strips according to the invention have an insulating layer coating of only 100 nm; this layer is to a very large extent composed of Fe₃O₄. The layer contains only a very small amount of Fe₂O₃; the Fe₃O₄ is clearly responsible for the insulating performance because a 100 nm thick blued layer according to the invention insulates better than a conventional 200 nm thick blued layer.

With this insulating performance, the blued electric steel strip produced according to the invention can render it unnecessary to provide the usual varnishing, which is a significant cost advantage compared to varnished sheet metals.

The method according to the invention provides for acting on the electric steel strip with compressed air at the entry into the final cooling zone, where it has a temperature of between 450° C. and 500° C. This sets an oxygen concentration of between 0.05% and 0.2%, measured in the furnace chamber of the final cooling zone. The absolute uniformity of the oxide layer produced is ensured on the one hand, through introduction of the compressed air into the blower housing of the final cooling blower and on the other hand, through the strip temperature and the oxygen concentration.

In addition, the injection of compressed air and the setting of the oxygen content according to the invention are performed so that the dew point is set to below −40° C. and a reducing atmosphere is set.

By contrast with the oxidizing atmosphere in conventional bluing, with water at dew points >10° C., the method according to the invention produces a layer that, while having a significantly lesser thickness, has a Fe₃O₄ content of 90% and more and at the reduced thickness, has such an elevated insulating capability that it can be easily used as a replacement for varnished electric sheet steels.

The method according to the invention also achieves a very high degree of uniformity, both with regard to the insulating power and layer composition and with regard to the layer thickness.

The invention will be explained in conjunction with the drawings.

### BRIEF DESCRIPTION OF THE DRAWINGS

FIG. 1 shows a highly schematic view of the sequence of the method according to the invention.

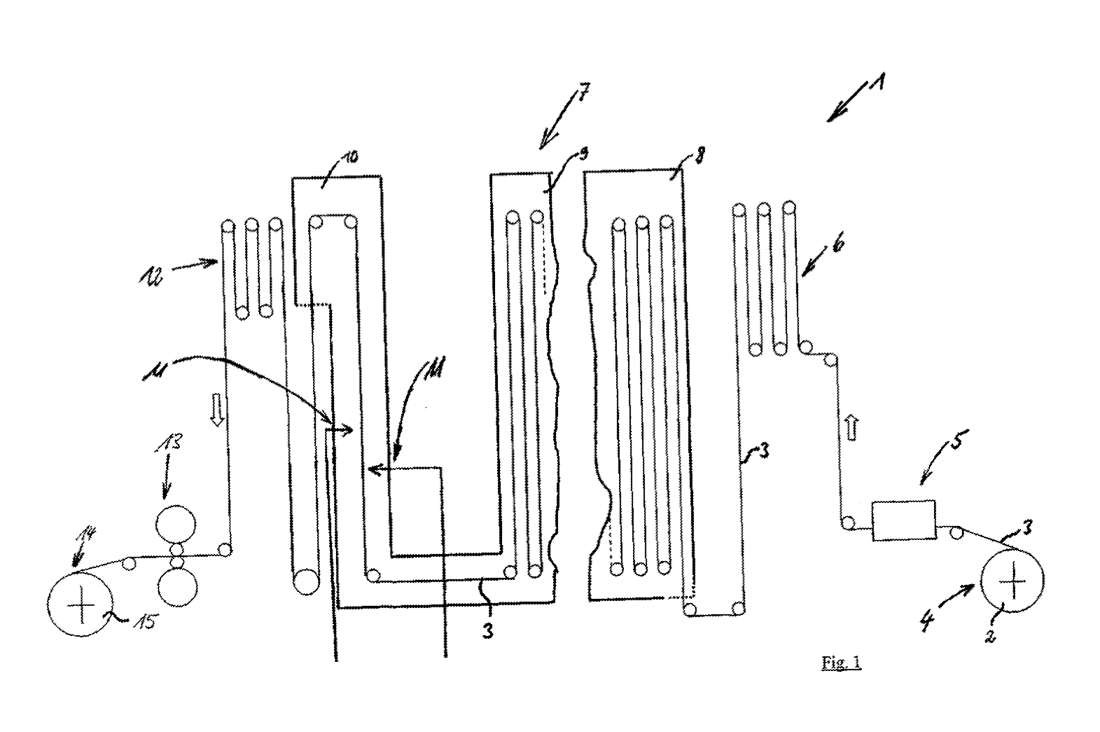

FIG. 2 shows a highly schematic view of the sequence of the method according to the prior art.

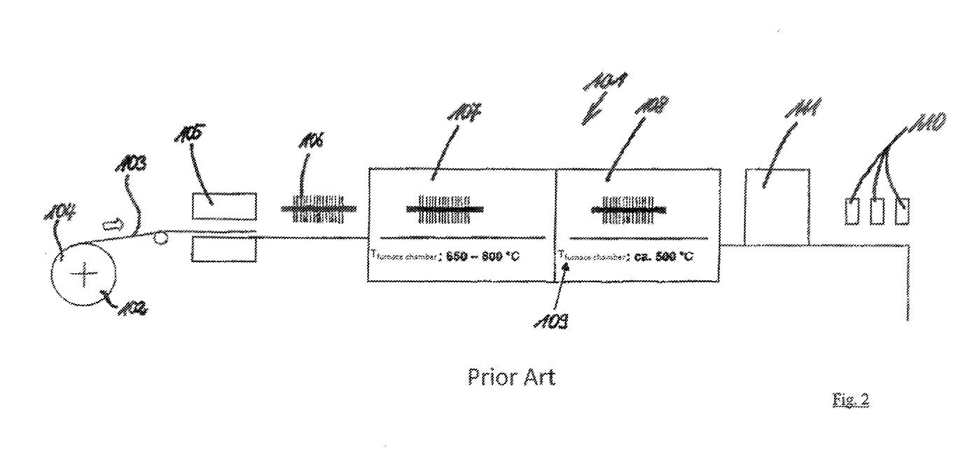

### DETAILED DESCRIPTION OF THE PREFERRED EMBODIMENTS

In particular, a continuous annealing line 1 is used with the method according to the invention. In this case, first, the steel strip 3 is unwound from a coil 2 of wound steel strip 3 at an uncoiling station 4 and then conveyed through a strip cleaning section 5. From the strip cleaning section 5, the steel strip 3 travels into an entry accumulator 6. The inherently known entry accumulator 6 has the task of ensuring uniform travel of the steel strip 3 through the subsequent units, because in order to ensure a continuous process, after the uncoiling of a first steel coil at the uncoiling station 4, a subsequent steel coil is uncoiled and the front end of the new steel coil is welded to the back end of the old steel coil in order to pull the new steel strip 3 through the continuous line. From the entry accumulator 6, the steel strip 3 travels into the actual annealing furnace or annealing device 7. In doing so, the steel strip first travels into a heating and cooling zone 8 and then travels from the heating and cooling zone 8 into a so-called overaging zone 9. From the overaging zone 9, the steel strip 3 travels into a final radiant cooling zone 10; the strip is conveyed from the overaging zone 9 to the final radiant cooling zone at approximately 450° C. to 500° C. In the final radiant cooling zone, according to the invention, the steel strip 3 is acted on with compressed air in corresponding regions 11; in the atmosphere 12 and/or in the interior 12 of the overaging zone and in the final radiant cooling zone, the dew point is set to below −20° C., in particular below −40° C., and preferably below −50° C. Then, the steel strip 3 travels out of the final radiant cooling into an exit accumulator 13, which has the task of taking in the steel strip 3 while a first steel strip is coiled and the subsequent, second steel strip is cut from the first steel strip in order to be subsequently coiled.

The steel strip 3 travels through a subsequent temper mill 14 and at a coiling station 15, is then wound back into a coil 16.

The invention has the advantage that the bluing and the production of an insulating oxide layer on the surface of the steel strip for use as electric steel is executed with a very high degree of uniformity and with a superior quality so that the oxide layer, because it is composed of more than 90% Fe₃O₄, offers a superior insulating power, even with a layer coating of only 100 nm.

Consequently, the electric steel strip with an oxide layer coating produced according to the invention can be used to replace varnished electric steels that are significantly more expensive to produce.

In addition, the end customer no longer requires varnishing equipment or bluing equipment, which on the one hand offers an investment advantage and on the other hand—particularly when the customer has existing bluing equipment—offers the advantage that the steel strip provided with the oxide layer according to the invention is of significantly better quality than a steel strip that can be produced by the customer in conventional bluing furnaces.

1. A method for producing an electric steel strip, in particular an iron oxide-coated steel strip for use as electric sheet steel for the electrical industry, comprising:
in a continuous annealing process, upon entry from an overaging zone into a final cooling zone, conveying a steel strip into a treatment chamber at a temperature between 450° C. and 550° C. and acting on the steel strip in the treatment chamber with an oxygen concentration of between 0.05% and 0.2% oxygen, measured in the final cooling zone; and
wherein the dew point of water is set to below −10° C. and the furnace chamber atmosphere is a reducing atmosphere.

2. The method as recited in claim 1, wherein the method is carried out so that an oxide layer forming on a surface of the steel strip has a thickness of under 150 nm.

3. The method as recited in claim 2, wherein the oxide layer thickness is set to be less than or equal to 100 nm.

4. The method as recited in claim 2, wherein a ratio of Fe₃O₄ to Fe₂O₃ in the oxide layer is at least 9:1.

5. The method as recited in claim 1, wherein the method is carried out in a final cooling zone of a continuous recrystallization annealing line.

6. The method as recited in claim 1, wherein the dew point of water is set to less than −40° C.

7. An electric steel strip for use in the electrical industry as an armature plate for armature cores and the like, in particular produced by the method as recited in claim 1, wherein the electric sheet steel strip has a surface oxide layer and the oxide layer contains more than 90% Fe₃O₄.

8. The electric steel strip as recited in claim 7, wherein the oxide layer coating is less than or equal to 150 nm thick.

9. The electric steel strip as recited in claim 7, wherein the oxide layer coating is less than or equal to 100 nm thick.

10. A use of an electric steel as recited in claim 7 for the production of laminated sheet metal cores with plates, which are insulated from one another, for stators and rotors of electric motors, generators, and the like.
